(19) United States
(12) Patent Application Publication
(10) Pub. No.: US 2011/0049324 A1
(43) Pub. Date: Mar. 3, 2011

(54) SLIDE ASSEMBLY FOR PARKING A VEHICLE

(76) Inventors: Kenneth Riley, Blaydon (GB); David William Carr, Newcastle Upon Tyne (GB)

(21) Appl. No.: 12/810,928

(22) PCT Filed: Jan. 9, 2009
(86) PCT No.: PCT/GB09/50015

§ 371 Date: Aug. 2, 2010

(30) Foreign Application Priority Data
Jan. 10, 2008 (GB) 0800392.3

(51) Int. Cl. F16M 11/04; F16M 13/00; F16M 11/08

(52) U.S. Cl. 248/425; 248/429

(57) ABSTRACT

A vehicle slide assembly (10) comprising a first rail assembly (12) and a second rail assembly (14) substantially parallel to the first rail assembly (12). Each rail assembly comprises a guide rail (20) and the slide assembly further comprises a vehicle wheel receiving platform (16, 18) engageable with a guide rail (20) and adapted to slide along a rail assembly by means of the guide rail.

The invention relates to a vehicle slide assembly, in particular a vehicle slide assembly that facilitates the movement of a vehicle within a confined space in order to allow optimisation of the space.

A number of properties are provided with a space for the storage of a vehicle or the like. The space may be in the form of an enclosed space such a garage or an open space such as a path or driveway on the property.

The existence of domiciles with more than one vehicle is becoming more and more commonplace. In certain properties the storage space is of a size suitable to accommodate more than one vehicle but access to the storage space is such that it is difficult to store more than one vehicle in the space at a time.

There exist devices in the art to facilitate the lateral movement of a vehicle in a confined space so as to allow optimisation of the space. One such device comprises a pair of parallel longitudinal panels which are linked to a wall mounted pulley system. The panels are connected with each other and spaced apart at a distance corresponding to the track of a vehicle. Each panel is mounted on a plurality of braces connected to a pair of transversely aligned wheels which facilitate the lateral movement of the device. In use, a user has to first align the wheels of a vehicle with the panels before driving the vehicle onto the panels such that the left side wheels are resting on one panel and the right side wheels are resting on the other panel. The user then actuates the pulley system in order to move the vehicle in a direction towards a wall confining the storage space thus creating more room for a second vehicle to be stored within the storage space.

With the device of the art, careful maneuvering of the vehicle is required in order to align the wheels with the panels of the device which may not be accomplished on the first attempt thus making the use of the device onerous and time consuming. Furthermore the requirement of a pulley system in order to move a vehicle increases the complexity of the installation of the device.

In storage spaces designed for single vehicle storage, a side of the storage space may be defined by a barrier, such as a wall or the like. This can make it difficult or inconvenient to gain access or exit a vehicle stored in the storage space in cases where the storage space is not sizably proportioned relative to the vehicle. This inconvenience can result in a user preferring not to utilise said storage space for its intended purpose, instead making use of an alternative arrangement to store his vehicle which may be less secure than the storage space.

According to the invention there is provided a vehicle slide assembly comprising a first rail assembly and a second rail assembly substantially parallel to the first rail assembly, each rail assembly comprises a guide rail and the slide assembly further comprises a vehicle wheel receiving platform engageable with a guide rail and adapted to slide along a rail assembly by means of the guide rail, wherein the vehicle wheel receiving platform is without lateral restrictions.

By means of the invention, therefore, a vehicle may be moved laterally within a confined storage space so as to allow optimisation of the space without the use of a pulley system. This is achieved by first driving the vehicle onto the slide assembly with the wheels of the vehicle placed on the platform. Once the vehicle is positioned on the platform, the vehicle is moved in a required direction by sliding the platform along one or both of the rail assemblies by means of a guide rail to create more room in the storage space thus allowing optimal use of the space to be achieved. The newly created space may be used for example to store a second vehicle within the storage space.

In addition, prior alignment of the wheels of the vehicle prior to driving the vehicle onto the platform is not required thus making lateral movement of a vehicle using the invention simpler and less time consuming than the device of the prior art.

In a first aspect of the invention, the slide assembly further comprises a second vehicle wheel receiving platform, adapted to slide along a rail assembly by means of a guide rail, spaced apart from the first platform at a distance corresponding to a wheelbase of a vehicle; the first platform being associated with the first rail assembly and the second platform being associated with the second rail assembly.

The provision of spaced apart platforms allows the slide assembly to be adjusted to accommodate vehicles having different wheelbase sizes without the need to replace the whole system. Additionally by having two separate platforms, manufacturing costs are reduced due to the fact that less material will be required than for a single platform extending across the length of the wheelbase of a vehicle.

The slide assembly may additionally comprise third and fourth vehicle wheel receiving platforms, the third platform being associated with the first rail assembly and the fourth platform being associated with the second rail assembly.

In this arrangement, in use, each wheel of a vehicle will be positioned on a separate platform. An advantage of having separate platforms for each wheel is that the slide assembly can be readily adjusted to accommodated vehicles having different track sizes thus making the system more versatile.

The guide rail of each rail assembly may be in the form of a fixed rail extending along a length of the rail assembly or may be in the form of a moving rail adapted to travel along a length of the rail assembly.

Preferably the or each platform is adapted to slide along a rail assembly by means of bearings. The bearings may be in the form of roller bearings or ball bearings incorporated into either the platform or the guide rail of the rail assembly.

Conveniently the bearings are incorporated into the guide rail of the rail assembly.

Preferably the bearings are self lubricating bearings so that minimal maintenance of the rail assemblies will be required after installation of the slide assembly.

Preferably each rail assembly further comprises a first barrier at a first end thereof in order to limit the movement of a platform along the rail assembly in a first direction, the first barrier defining an extreme for the movement of the platform along the rail assembly.

Preferably the first barrier comprises a rubber material and is of a suitable thickness to prevent contact of an end of a platform travelling along the rail assembly with a wall or fence confining the storage space.

Conveniently the first barrier is at least 15 cm long thus minimising the risk of a vehicle positioned on the slide assembly coming into contact with the wall confining the storage spaced when the vehicle is moved in a direction towards the wall.

The first and second rail assemblies may each further comprise a second barrier at a second end thereof, opposite the first end of the rail assembly in order to prevent a platform sliding along the rail assembly sliding off the rail assembly when in use.

Advantageously, the or each platform is made of a rigid material in order to prevent buckling of the platform when loaded with a vehicle wheel. The or each platform may be made of any suitable material such as timber, metal, hardened plastic or fibre glass. Ideally the or each platform is metallic and made from hardened steel.

The or each platform may further comprise at least one reinforcement strut extending along an underside of the platform to provide added strength to the platform and improve its rigidity.

Conveniently the or each platform comprises a plurality of restraining plates extending from an underside of the platform adapted to restrict transverse movement of the platform when engaged with a guide rail.

Preferably the or each platform comprises a ramp in order to facilitate loading of a vehicle wheel onto the platform.

Ideally the or each platform includes a wheel receiving section having a width of at least 98 mm.

Preferably each rail assembly further comprises a guide channel for aligning a platform with a guide rail. The guide channel may be located adjacent the guide rail or the guide rail may be housed within the guide channel of the rail assembly.

Preferably each rail assembly comprises at least one joining plate securely fastened to a guide rail or a guide channel. The use of a joining plate allows the rail assembly to be securely fastened to a surface such as a garage floor.

Ideally the at least one joining plate comprises at least one aperture for receiving a fastener for securing the rail assembly to a surface. The rail assembly may be securely fastened to the surface by any suitable means, for example by means of bolts, rivets or concrete screws.

The vehicle slide assembly may further comprise at least one protective cover adapted to cover a section of a rail assembly. This allows a section of the rail assemblies which would otherwise provide a trip hazard to be covered thus minimising the risk of a person tripping over the section of the rail assembly.

Preferably the at least one protective cover comprises a rubber material, a plastic material, fibre glass or other suitable material.

Ideally the protective cover comprises a flexible material such that in use, the protective cover adapts the shape of the section of rail assembly which it covers.

Advantageously each rail assembly comprises a plurality of substantially parallel guide rails for supporting a platform thereon.

In a second aspect of the invention, the slide assembly further comprises a second vehicle wheel receiving platform, adapted to slide along a rail assembly by means of a guide rail, spaced apart from the first platform at a distance corresponding to a track of a vehicle; the first platform being associated with the first rail assembly and the second platform being associated with the second rail assembly.

The arrangement according the second aspect of the invention facilitates the storage of a vehicle in storage spaces designed for single vehicle storage wherein a side of the storage space defined by a barrier makes it difficult or inconvenient to gain access or exit a vehicle stored in the storage space.

Preferably the slide assembly further comprises first and second detachable rail attachments adapted to respectively extend the length of the first and second rail assemblies.

By means of the rail attachments, the length of the rail assembly can be extended such that a user may gain access or exit a vehicle outside a storage space but still be able to position the vehicle within the storage space.

Preferably the or each platform further comprises a hinged flap extending from an end of thereof.

The hinged flap is adapted to create a ramp to facilitate the loading of a vehicle wheel onto the platform.

In a third aspect of the invention, the slide assembly further comprises a turntable section adapted to be mounted on the platform.

It is known for domiciles to have a motor vehicle such as a motorcycle or the like instead of or in addition to a car. A vast majority of motorcycles do not have a reverse gear. As a result it is generally cumbersome to remove a motorcycle out of an enclosed storage space as the motorcycle, which is generally quite heavy, has to be manually reversed out of the space.

By means of the third aspect of the invention, a motorcycle can be easily rotated 180 degrees by means of the turntable thereby removing the requirement to reverse the motorcycle and facilitating removal of the motorcycle from the storage space.

Preferably the turntable section is adapted to rotate about the platform by means of bearings. The bearings may be in the form of roller bearings or ball bearings.

The invention will now be described, by way of non limiting example, with reference to the accompanying drawings in which:

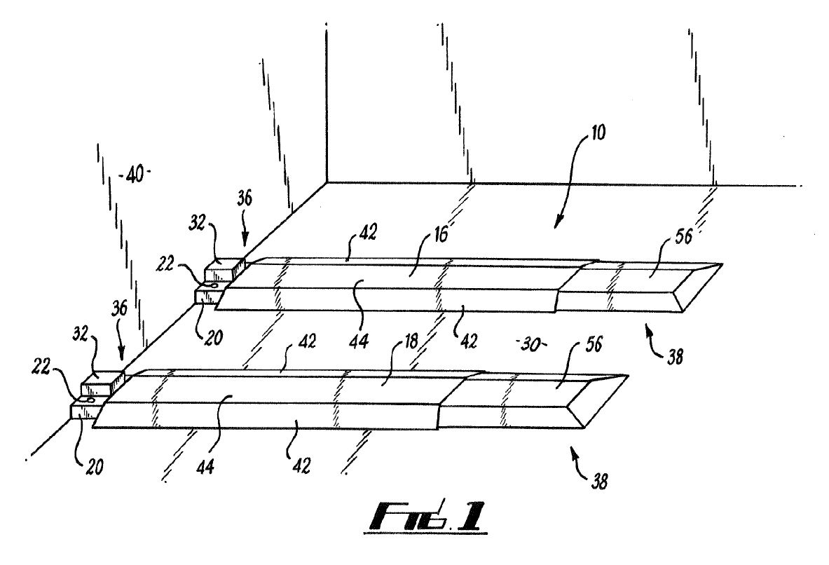

FIG. 1 is a perspective view of an embodiment of a slide assembly in accordance with a first aspect of the invention in a first position within an enclosed space;

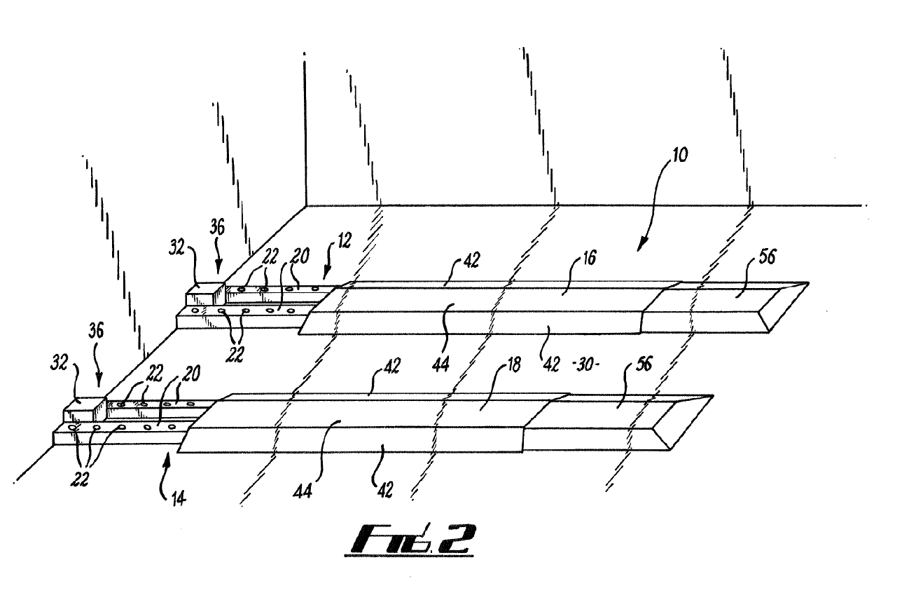

FIG. 2 is a perspective view of the slide assembly of FIG. 1 in a second position;

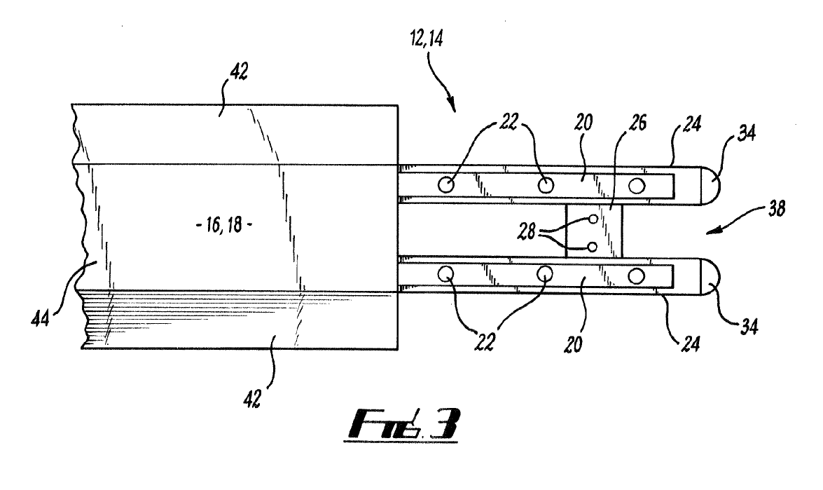

FIG. 3 is a plan view of a section of an embodiment of a platform and a rail assembly of the slide assembly of the invention;

FIG. 4 is a schematic view showing the positioning of the platform on the rail assembly in the embodiment of FIG. 3;

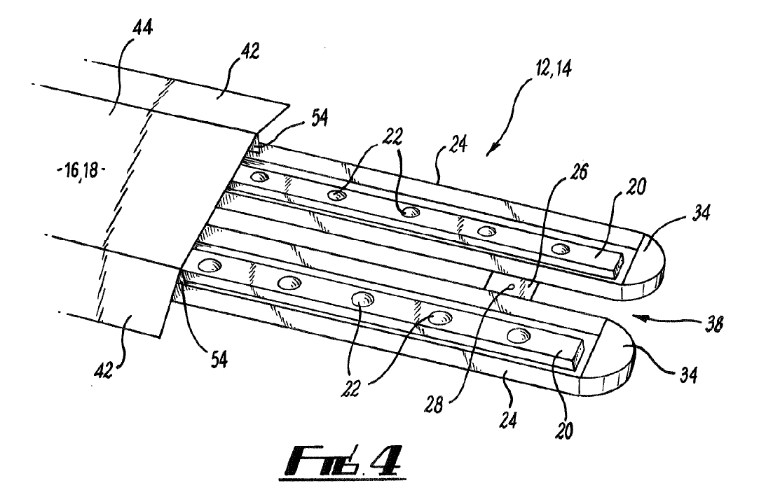

FIG. 5 is a schematic view showing the placement of a wheel of a vehicle on a platform of the invention;

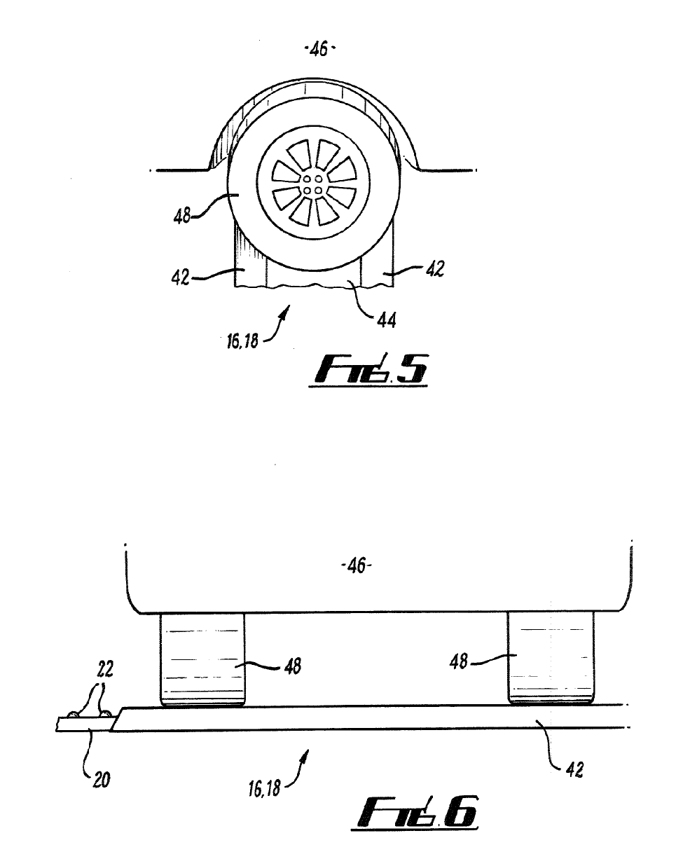

FIG. 6 is a schematic view showing the placement of the wheels of a vehicle on a platform of the invention;

FIG. 7 is a schematic view of the underside of a first embodiment of a platform of the invention;

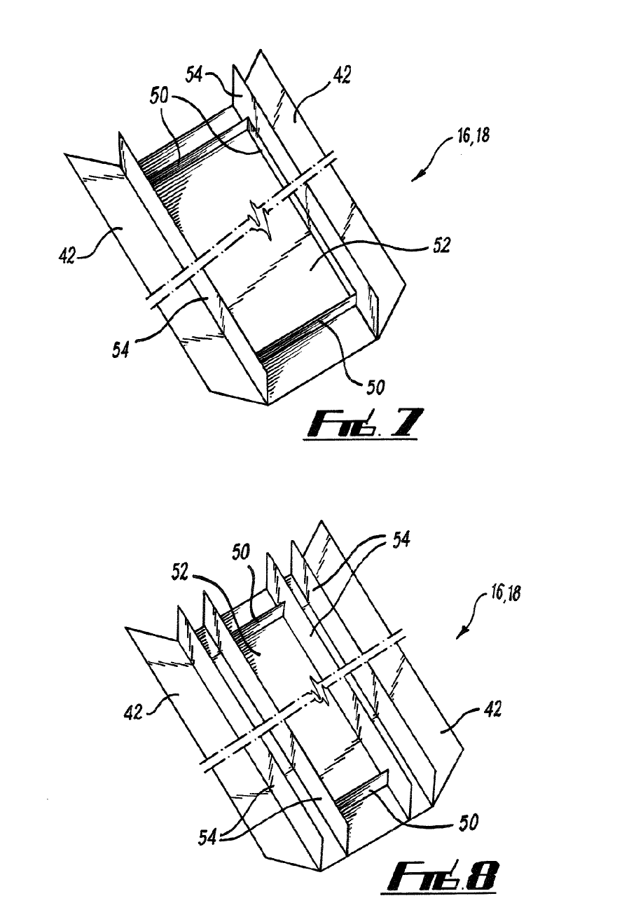

FIG. 8 is a schematic view of the underside of a second embodiment of a platform of the invention;

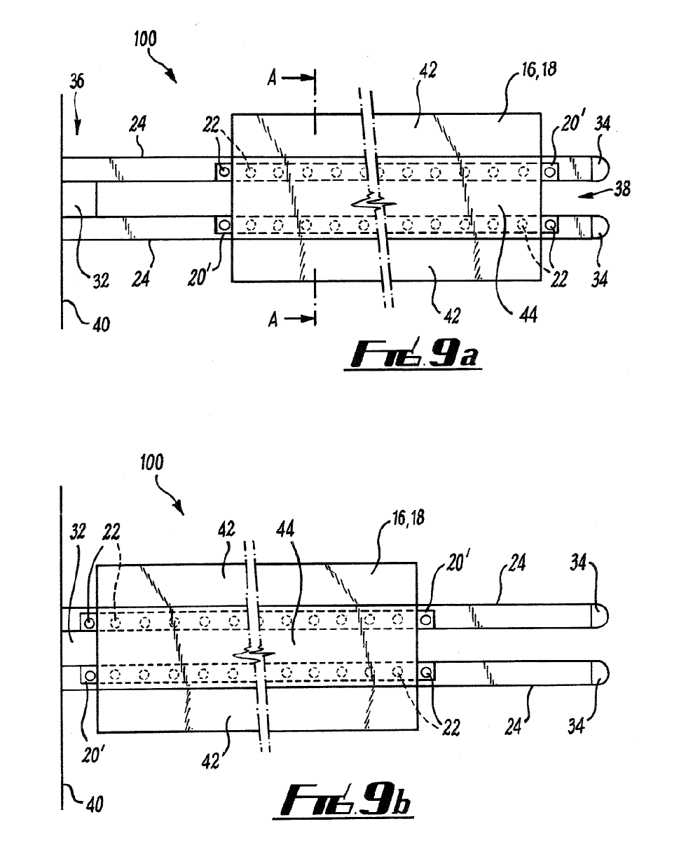

FIG. 9a is a plan view of a second embodiment of a slide assembly in accordance with a first aspect of the invention in a first position;

FIG. 9b is a plan view of the second embodiment of the invention in a second position;

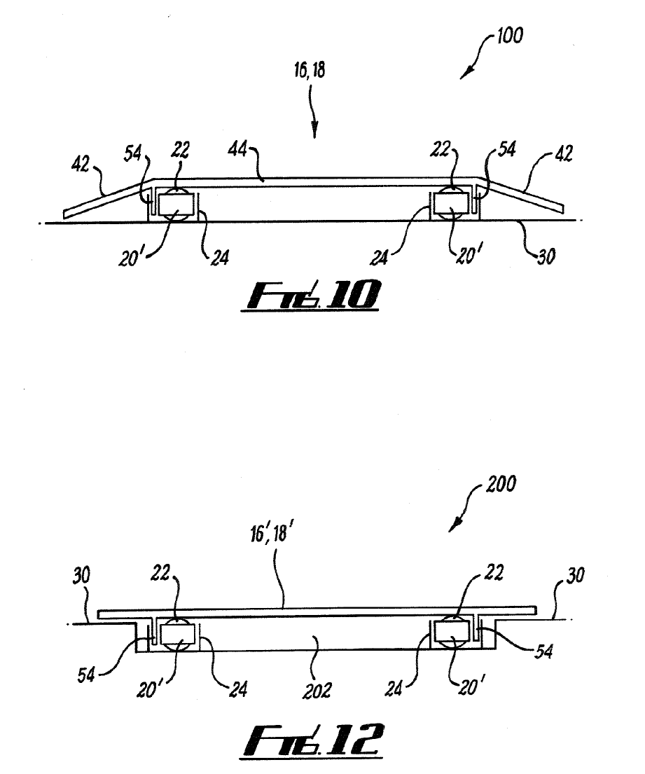

FIG. 10 is a cross-sectional view of the second embodiment of the invention taken across line A-A in FIG. 9a;

FIG. 11a is a plan view of a third embodiment of a slide assembly according to a first aspect of the invention in a first position;

FIG. 11b is a plan view of the third embodiment of the invention in a second position;

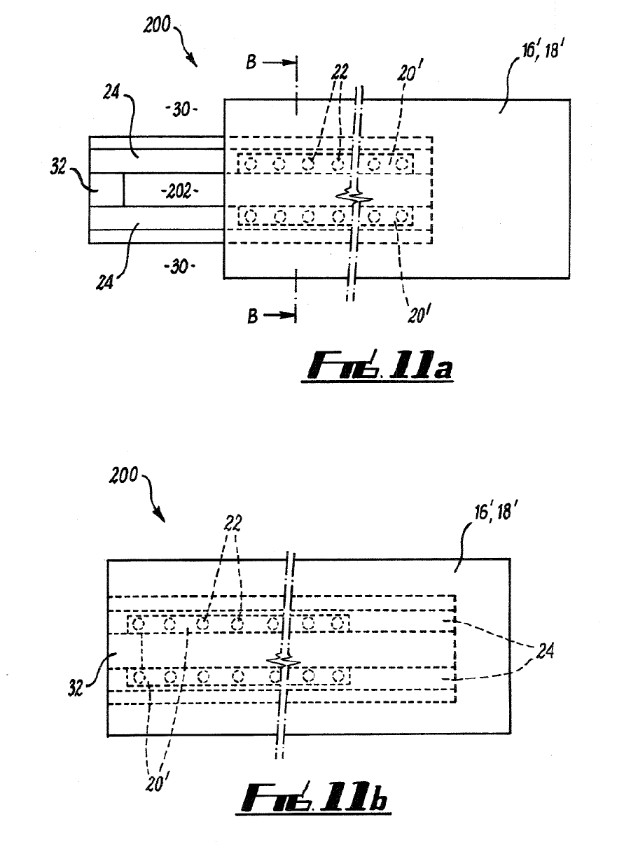

FIG. 12 is a cross-sectional view of the third embodiment of the invention taken across line B-B of FIG. 11a;

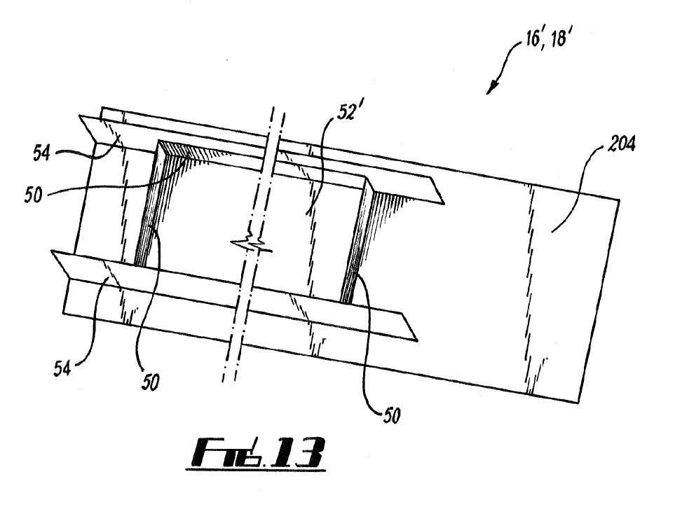

FIG. 13 is a schematic view of an underside of the platform of the slide assembly according to the third embodiment of the invention;

FIG. 14 is a schematic view showing the storage of a vehicle within a double garage;

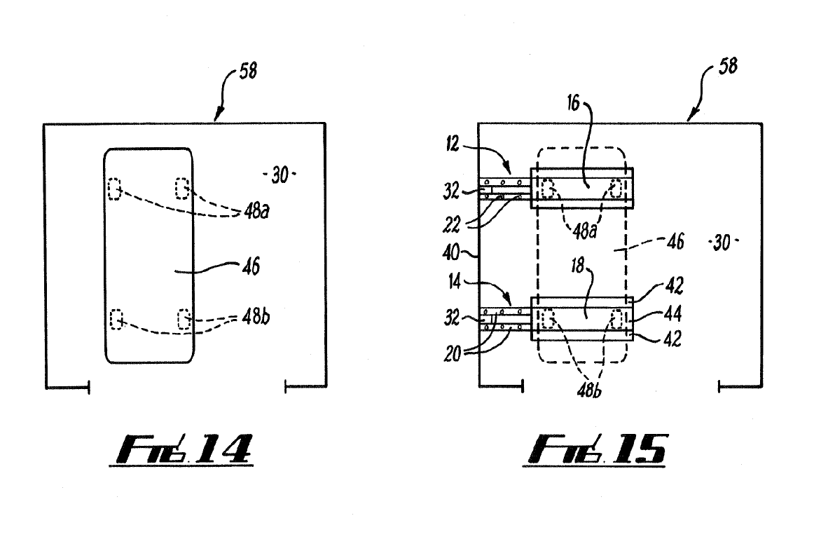

FIG. 15 is a schematic view of the garage of FIG. 14 incorporating an embodiment of a slide assembly according to the first aspect of the invention;

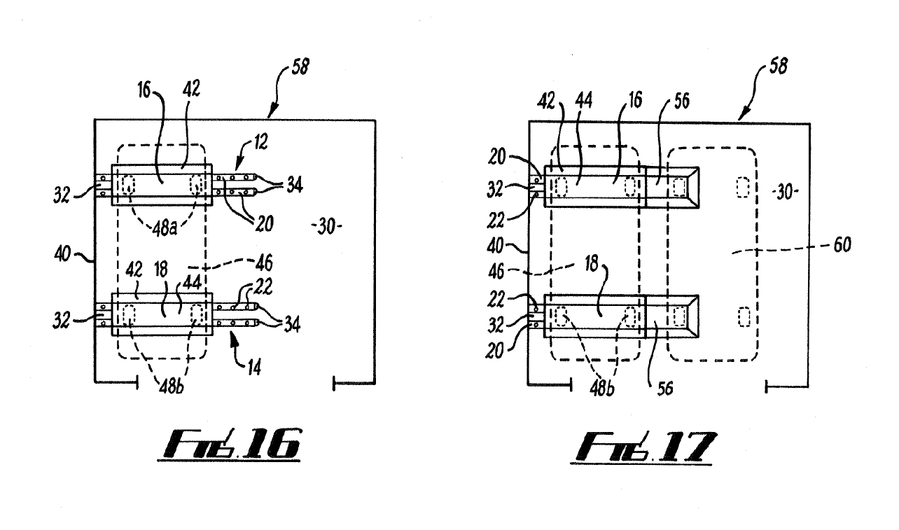

FIG. 16 is a schematic view showing the movement of a vehicle within the garage using the slide assembly of the invention;

FIG. 17 is a schematic view showing the storage of a second vehicle in the garage;

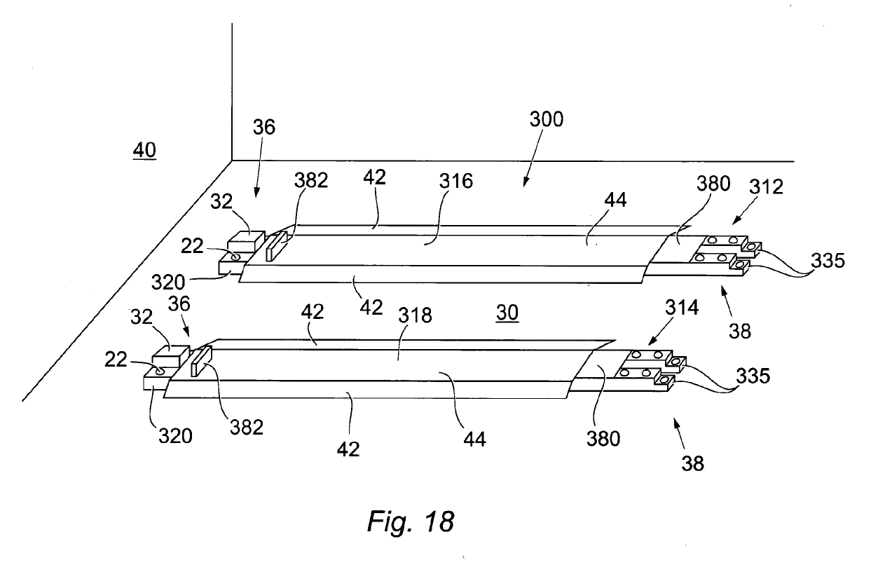

FIG. 18 is a perspective view of an embodiment of a slide assembly in accordance with a second aspect of the invention in a first position within an enclosed space;

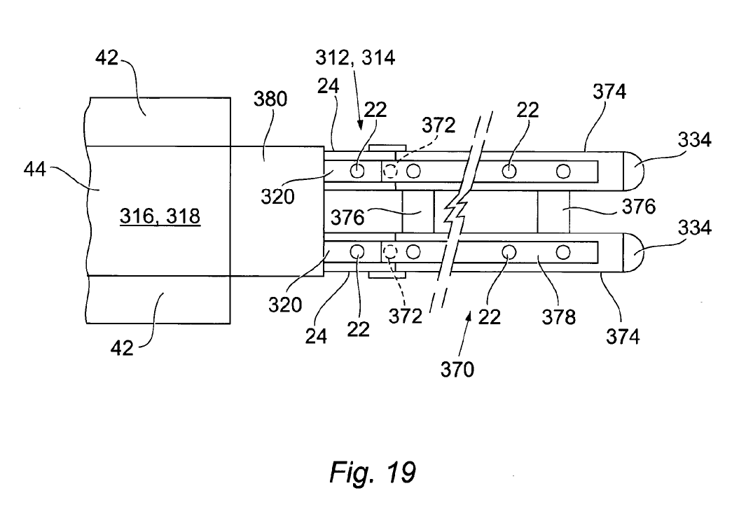

FIG. 19 is a plan view of a section of a third embodiment of a platform and a rail assembly for use with the second aspect of the invention;

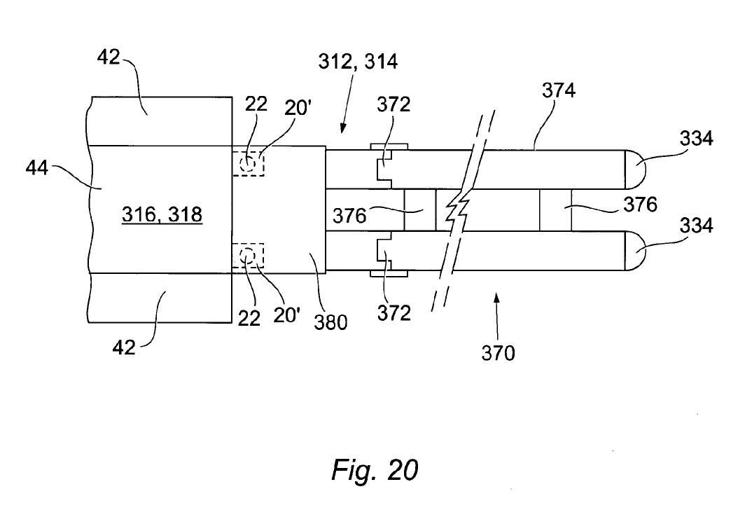

FIG. 20 is a plan view of a section of the third embodiment of the platform with an alternate rail assembly;

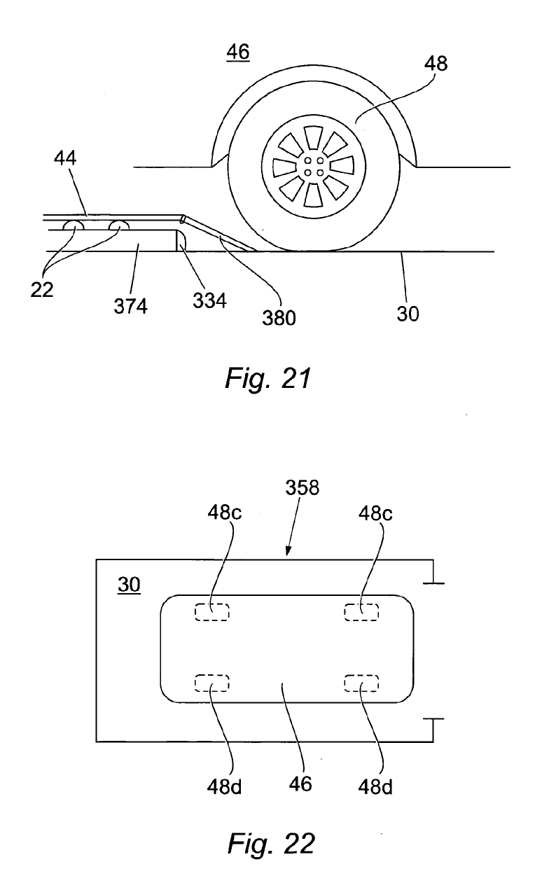

FIG. 21 is a side view of a flap forming part of the platform of the second embodiment of the invention in a ramp configuration;

FIG. 22 is a schematic view showing the storage of a vehicle within a single garage;

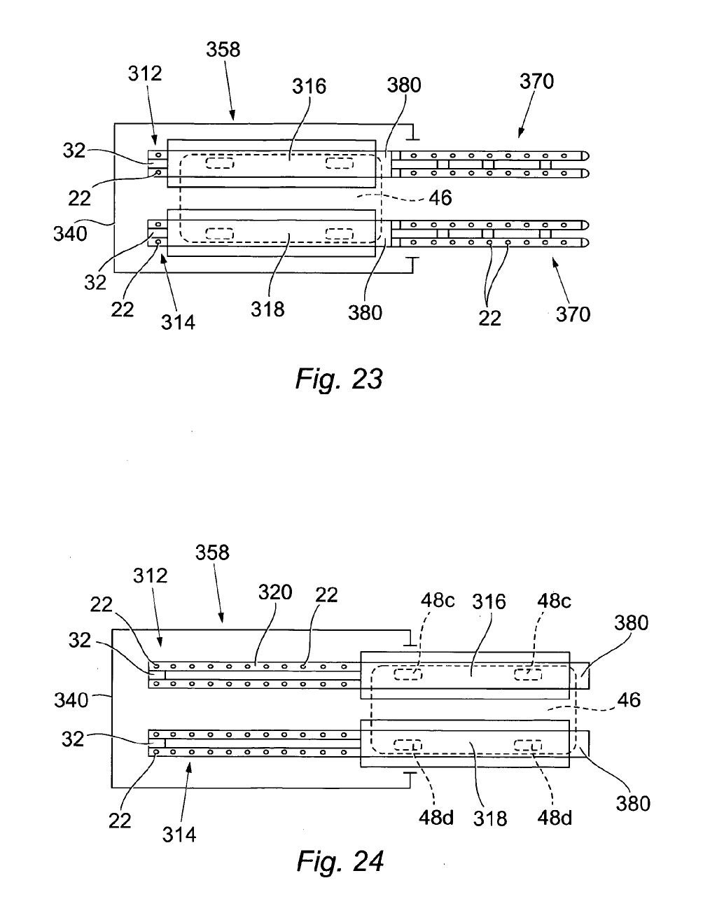

FIG. 23 is a schematic view of the garage of FIG. 22 incorporating a slide assembly in accordance with a second aspect of the invention;

FIG. 24 is a schematic view showing the movement of a vehicle within the single garage using the slide assembly according to a second aspect of the invention;

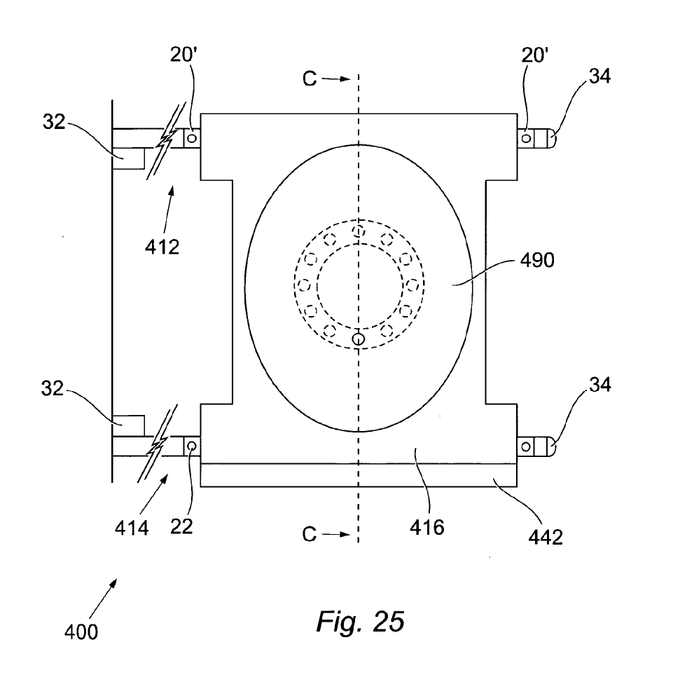

FIG. 25 is a plan view of an embodiment of a slide assembly in accordance with a third aspect of the invention;

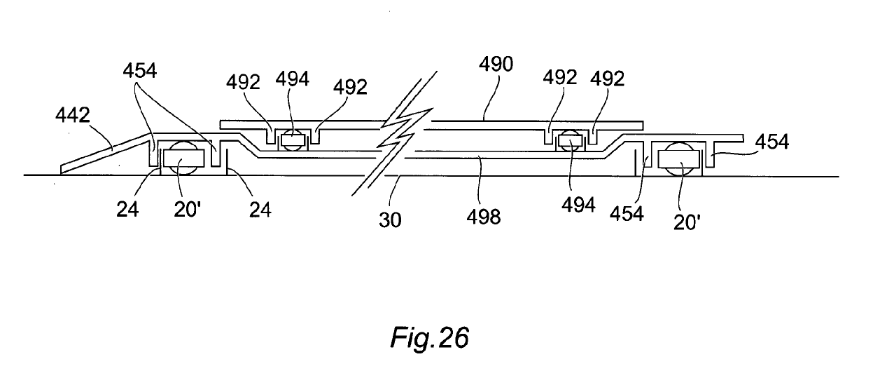

FIG. 26 is a cross-sectional view of the slide assembly in accordance with the third aspect of the invention taken across line C-C in FIG. 25;

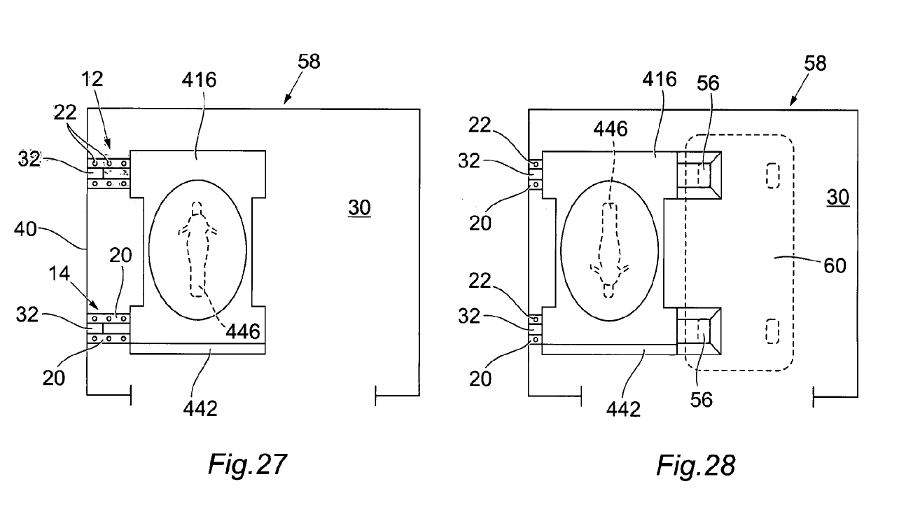

FIG. 27 is a schematic view of a double garage incorporating an embodiment of a slide assembly according to a third aspect of the invention; and

FIG. 28 is a schematic view showing the rotation and movement of a vehicle within the garage of FIG. 26 using the slide assembly according to the third aspect of the invention.

Referring to FIGS. 1 and 2, an embodiment of a slide assembly (10) according to a first aspect of the invention is shown within a confined storage space. The slide assembly (10) comprises a first rail assembly (12); a second rail assembly (14) substantially parallel to the first rail assembly (12); a first vehicle wheel receiving platform (16) associated with the first rail assembly (12) and a second vehicle wheel receiving platform (18) associated with the second rail assembly (14).

The first and second rail assemblies (12, 14) each comprise a pair of substantially parallel guide rails (20). The first and second platforms (16, 18) are engageable with and adapted to slide along the guide rails (20) of the corresponding rail assembly (12, 14). Each platform (16, 18) is adapted to slide along one or more guide rails (20) by means of ball bearings (22). The ball bearings (22) are incorporated in the guide rail (20) and are spaced apart from each other along the length of the guide rail (20) in order to facilitate the sliding of a platform (16, 18) along the guide rail (20).

Referring to FIGS. 3 and 4, each rail assembly (12, 14) further comprises a plurality of guide channels (24) corresponding in number to the number of guide rails (20) for aligning the guide rails (20) of the rail assembly (12, 14) with a platform (16, 18). In the embodiment shown, the guide rails (20) are housed in a corresponding guide channel (24).

Each rail assembly (12, 14) has at least one joining plate (26) having an end thereof securely fastened to one of the pair of guide channels (24) in order to keep them substantially parallel to each other. The at least one joining plate (26) includes at least one aperture (28) for receiving a fastener for securing the rail assembly (12, 14) to a surface such as a garage floor (30).

The first and second rail assemblies (12, 14) each further comprise a first barrier (32) at a first end (36) thereof (as can be seen in FIGS. 1 and 2) and a second barrier (34) at a second end (38) thereof (best shown in FIGS. 3 and 4). The first and second barriers (32, 34) are adapted to limit the movement of a platform (16, 18) along the rail assembly (12, 14).

The first barrier (32) comprises a rubber material and is of suitable thickness, preferably 15 cm or more, to prevent contact of an end of the platform (16, 18) travelling along the guide rails (20) from coming into contact with a wall or fence (40) confining the storage space.

The second barrier (34) is designed to seal off a track defined by the guide rails (20) such that the platform (16, 18) sliding along the guide rails (20) is prevented from sliding off the guide rails (20) when moved towards the second end (38) of the rail assembly (12, 14).

The first and second platforms (16, 18) are made from a rigid material such as hardened steel and each comprise a ramp (42) on either side of the platform (16, 18) to facilitate the loading of a vehicle wheel onto the platform (16, 18). Referring to FIGS. 5 and 6, each platform (16, 18) includes a wheel receiving section (44) having a width of at least 98 mm for receiving a wheel and is of a length greater than the wheel track of the vehicle.

Referring to FIG. 7, each platform (16, 18) comprises at least one reinforcement strut (50) extending along an underside (52) of the platform (16, 18).

The first and second platforms (16, 18) each further comprise a plurality of restraining plates (54) extending from an underside of the platform (16, 18) adapted to restrict transverse movement of the platform when engaged with the guide rails (20) of a corresponding rail assembly (12, 14). When the platform (16, 18) is engaged with the guide rails (20), a restraining plate (54) is positioned within an interior of a guide channel (24) of the corresponding rail assembly (12, 14) as indicated in FIG. 4.

In the embodiment shown in FIG. 7, the platform (16, 18) comprises a pair of restraining plates. An alternative arrangement of the restraining plates (54) on the underside of the platforms (16, 18) is shown in FIG. 8. In this embodiment the platform (16, 18) includes two pairs of restraining plates (54) spaced apart from each other defining a channel adapted to fit onto the guide rails (20) of the rail assembly (12, 14).

The vehicle slide assembly (10) further comprises a pair of protective covers (56) adapted to cover a section of each rail assembly (12, 14). In the embodiment shown, the covers (56) are adapted to cover a section of the rail assembly (12, 14) proximate the second end of the guide rails (20) of the rail assembly (12, 14). The covers are made from a rubber material and, as can be seem in FIGS. 1 and 2, adapt the shape of the rail assemblies (12, 14) of the slide assembly (10).

Referring to FIGS. 9a, 9b and 10, a second and preferred embodiment of a slide assembly (100) according to a first aspect of the invention is shown. The slide assembly (100) is very similar to the embodiment shown in FIGS. 1 and 2, with the two embodiments only differing in the arrangement of the rail assemblies (12, 14). In the second embodiment of the invention, each rail assembly (12, 14) comprises a pair of moving guide rails (20′) housed in a corresponding guide channel (24) rather than a pair of fixed guide rails.

Each guide rail (20′) comprises ball bearings (22) incorporated into a top surface and a bottom surface of the guide rail (20′), as best seen in FIG. 10, such that the guide rail (20′) moves together with the platform (16, 18) as it slides between the first end (36) and second end (38) of the rail assembly (12, 14) (see FIGS. 9a and 9b).

Referring to FIGS. 11a, 11b and 12, a third embodiment of a slide assembly (200) according to a first aspect of the invention is shown. In this embodiment the first and second rail assemblies (12, 14) are positioned in a cavity (202) in the floor (30) of the confined space. The rail assemblies (12, 14) may either comprise fixed guide rails (20) or moving guide rails (20′) as previously described. The rail assemblies (12, 14) are shown in FIGS. 11a, 11b and 12 with moving guide rails (20′).

Each platform (16′, 18′) is substantially flat, and as shown in FIG. 13, comprises at least one reinforcement strut (50) and a plurality of restraining plates (54) on an underside (52′) of the platform (16′, 18′).

Each platform (16′, 18′) further comprises a cover plate portion (204) adapted to cover a section of the cavity (202) when the platform (16′, 18′) is moved in a direction towards the first end (36) of the rail assembly (12, 14).

The application of a slide assembly according to a first aspect of the invention for the lateral movement a first vehicle in a confined space, such as a garage, in order to create room for the storage of a second vehicle in the confined space will now be described.

Referring to FIG. 14, a garage (58) in which an embodiment of the slide assembly (10, 100, 200) of the invention may be utilized is shown. The garage (58) is a suitable size to accommodate more than one vehicle but due to the size of the entrance to the garage, when a first vehicle (46) is stored within the garage it is difficult or impossible to store a second vehicle in the garage as the entrance is partially restricted.

Referring to FIGS. 15 to 17, the first embodiment of the slide assembly (10) according to a first aspect of the invention is shown installed in the garage (58) (a vehicle positioned in the garage (58) is shown with dashed lines for clarity). The first and second rail assemblies (12, 14) are secured to the floor (30) of the garage (58) using concrete screws in order to secure them in place and are spaced apart from each other at a distance corresponding to the wheelbase of a vehicle (46).

When a user wants to store two vehicles in the garage, the user first drives the first vehicle (46) onto the slide assembly (10) such that the front wheels (48a) of the vehicle (46) are positioned on the wheel receiving section (44) of the first platform (16) and the rear wheels (48b) of the vehicle (46) are positioned on the wheel receiving section (44) of the second platform (18) (see FIG. 15). The user may apply the hand brake in order to prevent the vehicle (46) from rolling off the platforms (16, 18) once the vehicle wheels (48) are suitably positioned.

The user then pushes the vehicle (46) in a direction towards a wall (40) of the garage in order to create more space for a second vehicle to be stored within the garage. The platforms (16, 18) will as a result slide along the guide rails (20) and move towards the first end (36) of the rail assemblies (12, 14). The movement of the platform (16, 18) will be halted either when the user stops pushing the vehicle (46) or the platforms (16, 18) come in contact with the first barrier (32) of the corresponding rail assembly (16, 18) (see FIG. 16).

Once the first vehicle (46) has been moved to the required position, a second vehicle (60) may now be stored in the garage (58) as shown in FIG. 17.

Prior to storing a second vehicle (60) in the garage, the user may cover any exposed section of the rail assemblies (12, 14) with a protective cover (56) in order to prevent a person from tripping over the exposed section. Alternatively, a protective cover (56) may be attached to an end of each of the platforms (16, 18) during installation of the slide assembly (10) thus alleviating the need for a protective cover (56) to be placed on a section of the rail assemblies (12, 14) after the platforms (16, 18) have been moved in a direction towards the first end (36) of the rail assemblies (12, 14).

When the user wants to remove the first vehicle (46) from the garage (58), all he has to do is pull the vehicle in a direction away from the wall (40) proximate the first end (36) of the rail assemblies (12, 14). Once the vehicle (46) is aligned with the entrance of the garage (58), the user reverses the vehicle out as normal.

While the first aspect of the invention has been described with particular reference to use in the optimisation of space for the storage of a second vehicle within a confined space, the invention may be used in any situation where lateral movement of a vehicle in a confined space is required. For example where movement of the vehicle provides better access to a passageway or doorway leading to the space, or extra room is required for the storage of boxes or items in the space.

Referring to FIG. 18, an embodiment of a slide assembly (300) according to a second aspect of the invention is shown within a confined storage space.

The slide assembly (300) is similar to that of the first aspect of the invention and same reference numerals have been used for the same features to that the first aspect of the invention for ease of reference. Reference numerals for similar features to that of the first aspect of the invention have been increased by a factor of 300 for ease of reference, for example the first rail assembly which was referred to with reference numeral 12 in the first aspect will have a reference numeral 312.

The differences between the slide assembly (300) according to the second aspect of the invention and that of the first aspect will now be described.

In the second aspect of the invention, the first and second rail assemblies (312, 314) instead of a second barrier at the second end (38) thereof each comprise a connecting member (335).

Referring to FIGS. 19 and 20, the slide assembly (300) further comprises first and second detachable rail attachments (370) adapted to respectively extend the length of the first and second rail assemblies (312, 314).

Each rail attachment (370) comprises, at a first end thereof, a reciprocal connecting member (372) adapted to engage with the connecting member (335) of the first and second rail assemblies (312, 314). In a preferred embodiment, the connecting members (335, 372) are adapted to interlock with one another.

The form of the attachments (370) is dependent on the type of rail assembly (312, 314) to which it is adapted to be connected to.

FIG. 19 shows an embodiment of the rail attachment (370) adapted to extend a rail assembly (312, 314) comprising a fixed guide rail (320). The rail attachment (370) comprises one or more guide channels (374) corresponding in number to that of the rail assembly (312, 314) and a fixed guide rail section (378) in each of the guide channels (374).

FIG. 20 shows an embodiment of the rail attachment (370) adapted to extend a rail assembly (312, 314) comprising a moving guide rail (20′). In this embodiment the rail attachment (370) comprises one or more guide channels (374) in which the moving guide rails (20′) may slide. The rail attachment (370) may further comprise a moveable guide rail section (not shown) adapted to be connected to an end of the moving guide rail (20′) in order to facilitate a minor extension of the length of the moving guide rail.

The first and second platforms (316, 318) each further comprise a hinged flap (380) extending from an end of thereof. The hinged flap (380) is adapted to create a ramp to facilitate the loading of a vehicle wheel onto the platform.

The hinged flap (380) is of the same width as the wheel receiving section (44) of the platform (316, 318) and in an at-rest position is supported by the guide channels (374) or the ball bearings (22) incorporated in the guide rail (320, 20′).

The hinged flap (380) comes to an active position which defines a ramp when the platform (316, 318) is moved towards a second barrier (334) at a second end of the rail attachments (370) (as best seen in FIG. 21).

The first and second platforms (316, 318) may each additionally comprise a wheel stop (382) positioned on the wheel receiving section proximate an edge of the platform at an end thereof opposite the end comprising the hinged flap (380).

Referring to FIG. 22, a single vehicle garage (358) in which an embodiment of the slide assembly (300) of the invention may be utilized is shown. The garage (358) is a suitable size to accommodate the vehicle but due to the width the garage, when a vehicle (46) is stored within the garage the amount a door may be opened is restricted thus making it difficult or impossible enter or exit the vehicle through the door.

Referring to FIGS. 23 to 24, an embodiment of the slide assembly (300) according to a second aspect of the invention is shown installed in the single storage garage (358) (a vehicle positioned in the garage (358) is shown with dashed lines for clarity). The first and second rail assemblies (312, 314) are secured to the floor (30) of the garage (358) using concrete screws in order to secure them in place and are spaced apart from each other at a distance corresponding to the track of a vehicle (46).

When a user wants to store the vehicle (46) in the garage, the user first attaches the rail attachments (370) to the free end of the first and second rail assemblies (312, 314). Auxiliary securing means, such as clamping means, may be provided to ensure the continued engagement of the first and second rail assemblies (312, 314) with a respective rail attachment (370) during the loading of a vehicle onto the slide assembly (300).

The first and second platforms (316, 318) are then slid along the slide assembly from the first and second rail assemblies (312, 314) towards the second end of the rail attachments (370) until the hinged flaps (380) pivot to define a ramp.

The user then drives the vehicle (46) onto the slide assembly (300) such that the right hand side wheels (48c) of the vehicle (46) are positioned on the wheel receiving section (44) of the first platform (316) and the left hand side wheels (48d) of the vehicle (46) are positioned on the wheel receiving section (44) of the second platform (318) (see FIG. 24). The user may apply the hand brake in order to prevent the vehicle (46) from rolling off the platforms (316, 318) once the vehicle wheels (48) are suitably positioned.

The user then pushes the vehicle (46) in a direction towards a wall (340) of the garage (358) in order to store the vehicle in the garage (358). The platforms (316, 318) will as a result slide along the guide rails (320) and move towards the first end (36) of the rail assemblies (312, 314). The movement of the platforms (316, 318) will be halted either when the user stops pushing the vehicle (46) or the platforms (316, 318) come in contact with the first barrier (32) of the corresponding rail assembly (316, 318) (see FIG. 23).

Once the vehicle (46) is stored in the garage (358), disengages the rail attachments (370) from the first and second rail assemblies (312, 314) and stores them away. The user may then cover any exposed section of the rail assemblies (312, 314) with a protective cover in order to prevent a person from tripping over the exposed section.

When the user wants to remove the vehicle (46) from the garage (358), all he has to do is reconnect the rail attachments (370) to the rail assemblies (312, 314) and pull the vehicle in a direction away from the wall (340) proximate the first end (36) of the rail assemblies (312, 314) until the vehicle has traveled out of the garage (358) far enough for the user to gain unhindered access into it.

Referring to FIGS. 25 and 26, an embodiment of a slide assembly (400) according to a third aspect of the invention, specially adapted for use with a motorcycle or the like, as such is shown. The same reference numerals have been used for features of the slide assembly (400) which are the same as that of the first aspect or second aspect of the invention for ease of reference. Reference numerals for similar features have been increased by a factor of 400 for ease of reference, for example the first rail assembly which was referred to with reference numeral 12 in the first aspect will have a reference numeral 412.

The slide assembly (400) comprises a first rail assembly (412); a second rail assembly (414) substantially parallel to the first rail assembly (412) and a wheel receiving platform (416) engageable with the guide rails of the first and second rail assemblies (412, 414) and adapted to slide along the rail assembly by means of the guide rail.

The rail assemblies (412, 414) maybe identical to those of the first aspect or those of the second aspect of the invention and as such will not be described in any further detail. In FIG. 25, the rail assembly is a rail assembly according to an embodiment of the first aspect of the invention wherein the first and second rail assemblies (412, 414) each comprise a single moving guide rail (20′).

The platform (416) is made from a rigid material such as hardened steel and comprises a ramp (442) at a first end of the platform (416) to facilitate the loading of a motorcycle onto the platform (416).

The platform (416) comprises a plurality of restraining plates (454) extending from an underside of the platform (416) adapted to restrict transverse movement of the platform when engaged with the guide rails (20′) of a corresponding rail assembly (412, 414). When the platform (416) is engaged with the guide rails (20′), a restraining plate (54) is positioned within an interior of a guide channel (24) of the corresponding rail assembly (12, 14) as indicated in FIG. 26. The platform (416) may also comprise one or more reinforcement struts (not shown) extending along an underside of the platform (416).

The platform (416) further comprises a recessed section (498) adapted to retain a turntable section (490) therein. The turntable is adapted to receive a motorcycle thereon.

Rotation of the turntable (498) about the platform (416) may be facilitated by any suitable means. In the embodiment shown said rotation is facilitated by means of ball bearings incorporate in a guide rail (494). While the ball bearings are shown incorporated into a top surface and a bottom surface of the guide rail (494), the ball bearings may be incorporated into the top surface of guide rail (494) only.

The recesses section (498) comprises a guide channel (496) in which the guide rail (494) is positioned.

The turntable (490) comprises a pair of restraining plates (492) extending from an underside of the turntable (490) adapted to facilitate positioning of the turntable (490) on the guide rail (494). When the turntable (490) is engaged with the guide rails (494), the restraining plates (492) are positioned on the outside of the guide channel (496).

As the rail assembly (400) is specially adapted for use with a motorcycle or the like, in use, the first and second rail assemblies (412, 414) need to be spaced apart from each other at a distance corresponding at least to the length of a motorcycle to allow 180 degree rotation of the turntable (490), and hence a motorcycle located thereon.

If a user has already installed a slide assembly according to a first aspect or second aspect of the invention all that is required is a corresponding platform (416) for the type of rail assembly set up. The user simply replaces first and second platforms with the single platform (416).

Referring to FIGS. 27 and 28, the utilization of the slide assembly (400) of the invention in the garage (58) of FIG. 15, wherein a first embodiment of the invention has been installed, is shown. A vehicle positioned in the garage (58) is shown with dashed lines for clarity.

When a user wants to store two vehicles in the garage, the first vehicle being a motorcycle (446), the user first replaces the first and second wheel receiving platforms (16, 18) with a motorcycle receiving platform (416). The user then rides the motorcycle (446) onto the slide assembly (400) such that the motorcycle (446) is positioned on the turntable section (490) of the platform (416) (see FIG. 27).

The user then rotates the turntable 180 degrees so that the front of the motorcycle (446) is facing the entrance of the garage (58). This makes it easier for the user to take the motorcycle (446) out of the garage (58) at a later stage.

The user then moves the motorcycle (446) in a direction towards the wall (40) of the garage in order to create more space for a second vehicle (in this case a car) to be stored within the garage (58). This is done by sliding the platform (416) along the guide rails (20) towards the first end (36) of the rail assemblies (12, 14). The movement of the platform (416) will be halted either when the user stops pushing or the platforms (16, 18) come in contact with the first barrier (32) of the corresponding rail assembly (16, 18) (see FIG. 28).

Once the motorcycle (446) has been moved to the required position, a second vehicle (60) may now be stored in the garage (58) as shown in FIG. 28.

Provided the platform (416) is adequately sized, the slide assembly (400) according to the third aspect of the invention may easily act as a dual function slide assembly adapted to facilitate both the movement of a motorcycle or a car as required.

Prior to storing a second vehicle (60) in the garage (58), the user may cover any exposed section of the rail assemblies (12, 14) with a protective cover (56) in order to prevent a person from tripping over the exposed section.

While the above description talks about manual movement of a vehicle along the first and second rail assemblies, it is to be understood that the movement of the vehicle can be automated by means of suitable mechanical or electrical devices of the type know in the art.

1. A vehicle slide assembly comprising a first rail assembly and a second rail assembly substantially parallel to the first rail assembly, each rail assembly comprises a guide rail and the slide assembly further comprises a vehicle wheel receiving platform engageable with a guide rail and adapted to slide along a rail assembly by means of the guide rail, wherein the vehicle wheel receiving platform is without lateral restrictions.

2. A slide assembly according to claim 1 wherein the first wheel receiving platform is adapted to receive a plurality of laterally spaced apart wheels of a vehicle.

3. A slide assembly according to claim 1 or claim 2 further comprising a second vehicle wheel receiving platform, adapted to slide along a rail assembly by means of a guide rail, spaced apart from the first platform at a distance corresponding to a wheelbase of a vehicle; the first platform being associated with the first rail assembly and the second platform being associated with the second rail assembly.

4. A slide assembly according to claim 3 when dependent on claim 1 further comprising third and fourth vehicle wheel receiving platforms, the third platform being associated with the first rail assembly and the fourth platform being associated with the second rail assembly.

5. A slide assembly according to claim 1 or claim 2 further comprising a second vehicle wheel receiving platform, adapted to slide along a rail assembly by means of a guide rail, spaced apart from the first platform at a distance corresponding to a track of a vehicle; the first platform being associated with the first rail assembly and the second platform being associated with the second rail assembly.

6. A slide assembly according to claim 5 further comprising first and second detachable rail attachments adapted to respectively extend the length of the first and second rail assemblies.

7. A slide assembly according to claim 5 or 6 wherein the or each platform further comprises a hinged flap extending from an end of thereof.

8. A slide assembly according to claim 1 wherein the slide assembly further comprises a turntable section adapted to be mounted on the platform.

9. A side assembly according to claim 8 wherein the turntable section is adapted to rotate about the platform by means of bearings.

10. A slide assembly according to anyone of the preceding claims wherein the said vehicle wheel receiving platform is a substantially flat platform.

11. A slide assembly according to any one of the preceding claims wherein the guide rail of a rail assembly is in the form of a fixed rail extending along a length of the rail assembly.

12. A slide assembly according to any one of claims 1 to 10 wherein the guide rail of a rail assembly is in the form of a moving rail adapted to travel along a length of the rail assembly.

13. A slide assembly according to any one of the preceding claims wherein the or each platform is adapted to slide along a rail assembly by means of bearings incorporated into the guide rail of the rail assembly.

14. A slide assembly according to any one of the preceding claims wherein each rail assembly further comprises a first barrier at a first end thereof.

15. A slide assembly according to claim 14 wherein the first barrier comprises a rubber material.

16. A slide assembly according to claim 14 or claim 15 wherein the first barrier is at least 15 cm long.

17. A slide assembly according to any one of claims 14 to 16 wherein the first and second rail assemblies each further comprise a second barrier at a second end thereof, opposite the first end of the rail assembly.

18. A slide assembly according to any one of the preceding claims wherein the or each platform is made of a rigid material.

19. A slide assembly according to claim 18 wherein rigid material is hardened steel.

20. A slide assembly according to any one of the preceding claims wherein the or each platform comprises at least one reinforcement strut extending along an underside of the platform.

21. A slide assembly according to any one of the preceding claims wherein the or each platform comprises a plurality of restraining plates extending from an underside of the platform.

22. A slide assembly according to any one of the preceding claims wherein the or each platform comprises a ramp.

23. A slide assembly according to any one of the preceding claims wherein the or each platform includes a wheel receiving section having a width of at least 98 mm.

24. A slide assembly according to any one of the preceding claims wherein each rail assembly further comprises a guide channel for aligning a platform with a guide rail.

25. A slide assembly according to anyone of the preceding claims wherein each rail assembly comprises at least one joining plate.

26. A slide assembly according to claim 25 wherein the at least one joining plate comprises at least one aperture for receiving a fastener for securing the rail assembly to a surface.

27. A slide assembly according to any one of the preceding claims further comprising at least one protective cover adapted to cover a section of a rail assembly.

28. A slide assembly according to claim 27 wherein the at least one protective cover comprises a rubber material.

29. A slide assembly according to claim 27 or claim 28 wherein the protective cover comprises a flexible material.

30. A slide assembly according to any one of the preceding claims wherein each rail assembly comprises a plurality of substantially parallel guide rails for supporting a platform thereon.

31. A slide assembly as generally hereinbefore described with reference to and/or illustrated in the accompanying drawings.
